(19) United States
(12) Patent Application Publication
(10) Pub. No.: US 2015/0242955 A1
(43) Pub. Date: Aug. 27, 2015

(54) Preauthorization Knowledgebase System

(71) Applicant: Passport Health Communications, Inc., Franklin, TN (US)

(72) Inventors: Amanda Barrett Long, Boca Raton, FL (US); Ciby Panicker Abraham, Wyncote, PA (US); Elizabeth Furst, Madison, WI (US); Anil George, Chalfont, PA (US); Robert Bradley Mergner, JR., Pipersville, PA (US); Nikhil K. Oza, Souderton, PA (US); Shridar Vijay, Morganville, PA (US); Ramanujam Iyengar, Holmdel, NJ (US)

(73) Assignee: Passport Health Communications, Inc., Franklin, TN (US)

(21) Appl. No.: 14/626,860

(22) Filed: Feb. 19, 2015

Related U.S. Application Data
(60) Provisional application No. 61/942,811, filed on Feb. 21, 2014.

(51) Int. Cl. G06Q 40/08; G06Q 50/22

(52) U.S. Cl. CPC G06Q 40/08; G06Q 50/22

(57) ABSTRACT

A preauthorization knowledgebase system. The preauthorization knowledgebase system parses relevant information from an order submitted by a health care provider and compares that information against a set of rules used to determine whether preauthorization is required for a medical service specified in the order. The rules are arranged into various hierarchical levels from payer level to procedure level. Even if the order is incomplete, the preauthorization knowledgebase system checks as many of the hierarchical levels as possible with the information provided. The preauthorization knowledgebase system returns a result indicating whether preauthorization is required for the order and, optionally, the hierarchical level(s) requiring preauthorization.

### CROSS-REFERENCE TO RELATED APPLICATIONS

This application claims the benefit of U.S. Provisional Patent Application No. 61/942,811, titled “Preauthorization Knowledgebase System” filed Feb. 21, 2014.

### BACKGROUND

Most, if not all, payers of health insurance benefits have rules requiring beneficiaries of a health insurance plan to obtain preauthorization for certain medical services. For example, the payer may require preauthorization for medical services that are deemed expensive, experimental, and/or routinely unnecessary. If preauthorization in not obtained, the payer is not obligated to pay for the medical service. The rules and procedures for obtaining preauthorization are different for each payer and may vary between the different insurance plans offered by a single payer.

Obtaining preauthorization is generally too complicated or burdensome for the patient. Accordingly, health care providers shoulder the responsibility of learning the unique rules and procedures relating to preauthorization for each health insurance plan offered by each payer with whom the health care provider works. All too often, the rules about what medical services require preauthorization and/or the procedures for obtaining preauthorization are not well-documented or readily available to the insured or the health care provider and may change without notice.

The problems associated with preauthorizations faced by health care providers include difficulty in identifying medical services that require preauthorization for different plans and payers, procedural issues relating to submitting requests for preauthorization, and keeping track of pending requests to ensure that preauthorization is obtained. Dealing with these problems adds administrative overhead in the form of additional staff, special procedures, and/or ongoing training, all of which increases expenses of the health care provider. An estimated $31 billion per year is spent dealing with prior authorizations. The consequences of mistakes when preauthorization is required include, for example, claim payments being delayed to claims being denied and unpaid. It is with respect to these and other considerations that the present invention has been made.

### BRIEF SUMMARY

Various embodiments of a preauthorization knowledgebase system parse relevant information from an order submitted by a health care provider and compare that information against a set of rules used to determine whether preauthorization is required for a medical service specified in the order. The rules are arranged into various hierarchical levels from payer level to procedure level. Even if the order is incomplete, the preauthorization knowledgebase system checks as many of the hierarchical levels as possible with the information provided. The preauthorization knowledgebase system returns a result indicating whether preauthorization is required for the order and, optionally, the hierarchical level(s) requiring preauthorization.

The preauthorization knowledgebase system communicates with a client device, the provider information system, and/or a payer system over a computer network, such as the Internet. The preauthorization knowledgebase system includes a preauthorization knowledgebase engine running on a computing device. The preauthorization knowledgebase engine is in communication with one or more databases including, but not limited to, a rules database, an order database, and a work queue database. In various embodiments, the preauthorization knowledgebase engine runs as a web service that accepts web service calls from a front end system running an interface engine that receives the order from the client device, optionally preprocesses selected information from the order, and passes selected information to the preauthorization knowledgebase engine. The rules database contains a set of rules used to determine whether preauthorization is required based on information provided in the order. The order database contains the orders received from the health care provider and related information. The work queue database contains groupings of orders based on the results of the determinations by the preauthorization knowledgebase system.

The preauthorization knowledgebase method performed by the preauthorization knowledgebase system begins when the preauthorization knowledgebase system receives an order for medical services or a preauthorization lookup inquiry from the health care provider. The preauthorization knowledgebase method includes an information collection operation that parses the information needed by the preauthorization knowledgebase engine to determine if preauthorization is required from the order. A rule application operation compares the parsed information to some or all of the rules used to determine whether the preauthorization is required for a medical service specified in the order. The general result is a yes or no answer that indicates whether preauthorization is required based on the information available to the preauthorization knowledgebase system. Some embodiments of the preauthorization knowledgebase system also provide information as to the basis of determination.

In various embodiments, the rule application operation involves a series of comparisons at various hierarchical levels. The rule application operation performs as many different checks as possible based on the data received. Accordingly, the specificity of the result of rule application operation is directly related to the data received. If complete information is provided, the rule application information can perform all of the hierarchical comparisons and return detailed information of the results of the comparisons at the various hierarchical levels. Where less than complete information is provided to the preauthorization knowledgebase system, the general result may offer guidance as to whether further inquiry is required due to the hierarchical nature of the comparisons. A report displayed to the user shows whether preauthorization is required based on the information provided and, optionally, shows which hierarchical level(s) require preauthorization for the order.

### BRIEF DESCRIPTION OF THE DRAWINGS

Further features, aspects, and advantages of the invention represented by the embodiments described present disclosure will become better understood by reference to the following detailed description, appended claims, and accompanying Figures, wherein elements are not to scale so as to more clearly show the details, wherein like reference numbers indicate like elements throughout the several views, and wherein:

FIG. 1 illustrates one embodiment of the preauthorization knowledgebase system in a suitable operating environment;

FIG. 2 is a high level flowchart of one embodiment of the method performed by the preauthorization knowledgebase system;

FIG. 3 is a high level flowchart of an alternate embodiment of the method performed by the preauthorization knowledgebase system; and

FIG. 4 is a simplified block diagram illustrating example physical components of a computing device with which embodiments of the system may be practiced.

### DETAILED DESCRIPTION

A preauthorization knowledgebase system is described herein and illustrated in the accompanying figures. The preauthorization knowledgebase system parses relevant information from an order submitted by a health care provider and compares that information against a set of rules used to determine whether preauthorization is required for a medical service specified in the order. The rules are arranged into various hierarchical levels from payer level to procedure level. Even if the order is incomplete, the preauthorization knowledgebase system checks as many of the hierarchical levels as possible with the information provided. The preauthorization knowledgebase system returns a result indicating whether preauthorization is required for the order and, optionally, the hierarchical level(s) requiring preauthorization.

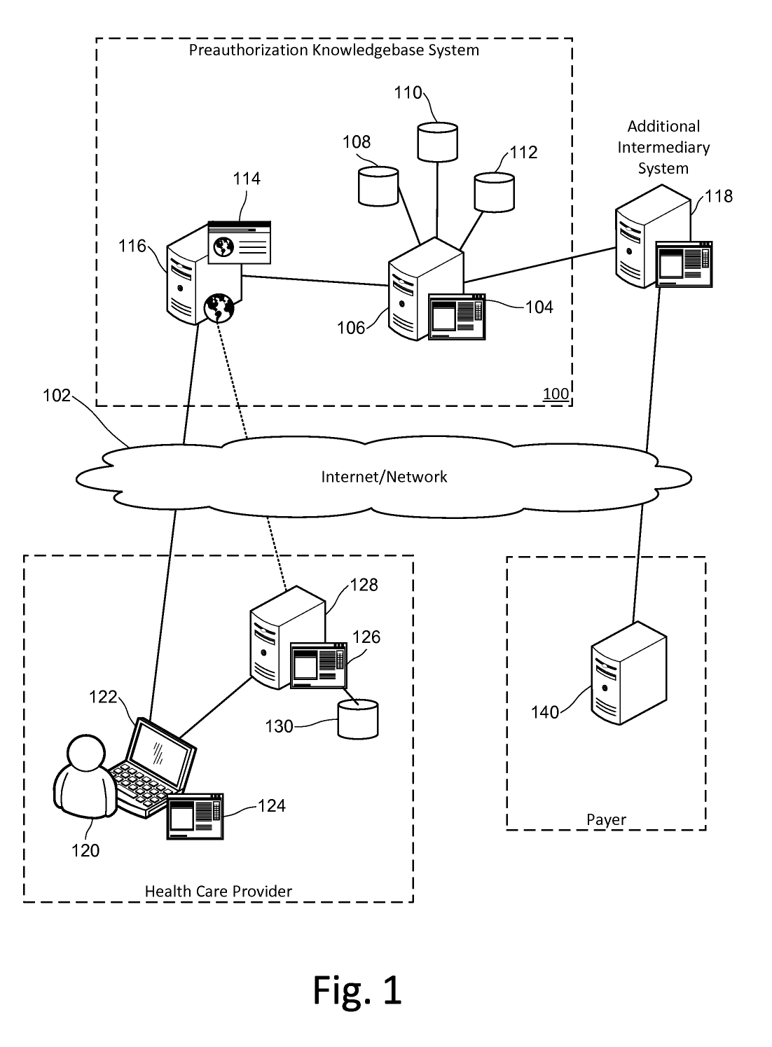

FIG. 1 illustrates one embodiment of the preauthorization knowledgebase system in a suitable operating environment. The preauthorization knowledgebase system 100 may be maintained and operated by an intermediary service provider that acts as interface between health care providers and payers to normalize communication solutions, data requirements, and transaction formats. In some embodiments, the preauthorization knowledgebase system 100 is maintained by the health care provider. The preauthorization knowledgebase system 100 communicates with a client device 122, the provider information system 126, and/or a payer system 140 over a computer network 102, such as the Internet.

The preauthorization knowledgebase system 100 includes a preauthorization knowledgebase engine 104 running on a computing device 106. The preauthorization knowledgebase engine 104 is in communication with one or more databases including, but not limited to, a rules database 108, an order database 110, and a work queue database 112. While described as separate databases, the data storage of the preauthorization knowledgebase system 100 may be distributed among multiple databases or consolidated in a single database.

The functionality of the preauthorization knowledgebase system 100 may be distributed among multiple computing devices or consolidated in a single computing device. In various embodiments, the preauthorization knowledgebase system 100 utilizes multiple servers with different assigned roles. For example, a highly distributed preauthorization knowledgebase system 100 may include a front end server (e.g., an application server or web server) that operates as the interface for communications with the health care provider, a database server that manages the data collected by the preauthorization knowledgebase system 100, and a back end server (e.g., an application server or web server) that determines whether preauthorization is required.

In the illustrated embodiment, the preauthorization knowledgebase engine 104 runs as a web service that accepts web service calls from a front end system 114 running an interface engine 116 that receives the order from the client device, optionally preprocesses selected information from the order, and passes selected information to the preauthorization knowledgebase engine 104. The preauthorization knowledgebase system 100 may be in communication with (or a component of) another intermediary system 118 such as a preauthorization management system that includes functionality to submit preauthorization requests to the payer system when required and monitor the status of pending preauthorization requests until a final determination (i.e., approval or rejection) is made. In an alternative embodiment, all interface, parsing, preprocessing, and rule application functions are handled directly by the preauthorization knowledgebase engine 104.

The rules database contains a set of rules used to determine whether preauthorization is required based on information provided in the order. The rules are arranged in various hierarchical levels allowing different rules to be check based on the information received by the preauthorization knowledgebase engine 104. Examples of the hierarchical levels, in order from most general to most granular, at which comparisons may occur include, but are not limited to, the payer level, the plan level, the service line level, the modality level, the contract level, the employer level, and the procedure (i.e., diagnosis and/or treatment) level. In various embodiments, the preauthorization knowledgebase system 100 checks as many of the hierarchical levels as possible with the information provided. The order database contains the orders received from the health care provider and related information such as, but not limited to, the result of the preauthorization requirement determination and the hierarchical level(s) at which preauthorization is required. The work queue database contains groupings of orders based on the results of the determinations by the preauthorization knowledgebase system 100. The groupings in the work queue database may also be based on additional information evaluated in conjunction with the results of the determinations by the preauthorization knowledgebase system 100.

The illustrated embodiment shows a user 120 accessing the preauthorization knowledgebase system via the client device such as, but not limited to, a general computing device and a mobile computing device (e.g., a smart phone or tablet). The client device is generally capable of running a user agent 124 used to access the preauthorization knowledgebase system. Examples of suitable user agents include, but are not limited to, a web browser and a preauthorization knowledgebase system client application. In various embodiments, the user agent compatible with the preauthorization knowledgebase system is capable of rendering a hypertext markup language (HTML) document.

The health care provider may also maintain a provider information system running on a computing device 128. The provider information system includes a database 130 storing business and patient information used by the health care provider, such as insurance information, electronic medical records, billing information, and appointments. In various embodiments, the provider information system interfaces with the preauthorization knowledgebase system. In some embodiments, the preauthorization knowledgebase system may update authorization records stored by the provider information system with information received from the payer system including, but not limited to, transaction identifiers used to track specific pending preauthorization requests and authorization codes indicating approval (or rejection) of a preauthorization request. In some embodiments, the client device accesses the preauthorization knowledgebase system through the provider information system. In some embodiments, the client device and the provider information system are consolidated into a single computing device.

Various embodiments of the preauthorization knowledgebase system use a combination of electronic data interchange (EDI) transactions, web services, web forms, and web pages to interactively communicate with the client device, provider information system, and/or the payer system. Communications (i.e., messages) between the preauthorization knowledgebase system, client device, provider information system, and the payer system are encrypted or otherwise secured at or above the level required to comply with applicable health care information privacy laws, regulations, and standards. The terms “request” and “response” may be used to generally describe message directionality and should not be construed as requiring any particular communication method or protocol.

EDI transactions are based on a standardized interface using strictly formatted messages representing documents that allows the preauthorization knowledgebase system and the payer system to exchange and understand information with little to no human intervention. Human intervention in the processing of a received message by either system is typically limited to dealing with error conditions, quality review, and other special situations. Examples of a suitable EDI health care transaction formats include, but are not limited to, HL7, 278, and X12.

Web service transactions are through an interface described in a computer readable format such as the Web Service Definition Language (WSDL) that defines the access point(s), method(s), and other specifications of the web service. The web service uses protocols such as, but not limited to, the Simple Object Access Protocol (SOAP) for communication. The messages sent and received by the web service contain the actions and corresponding information specified in the web service definition. The messages are written using use data formats such as, but not limited to, the Extensible Markup Language (XML) and the Security Assertion Markup Language (SAML). The messages are typically sent over the Internet using transport protocols such as, but not limited to, the Hypertext Transfer Protocol (HTTP), the Hypertext Transfer Protocol Secure (HTTPS), or the Simple Mail Transfer Protocol (SMTP). The web service may be a Representational State Transfer (REST) compliant service with a uniform set of methods or an arbitrary service with an arbitrary set of methods.

The preauthorization knowledgebase system may be a module or component of a larger health care information system or health care management suite offered by the intermediary service provider providing functionality including, but not limited to, any or all of patient intake, patient record maintenance, insurance eligibility verification, order checking, and claim submission. While user interactions may be described as if directly handled by the preauthorization knowledgebase system, it should be appreciated that the user interactions may actually be handled by one or more other components of the larger system at different times and the information from those user interactions made available the preauthorization knowledgebase system. For example, a health care provider may enter patient and insurance information into a patient information module during intake, order information into an order checking module after the physician has seen the patient, and additional information needed to complete a preauthorization request into the preauthorization knowledgebase system.

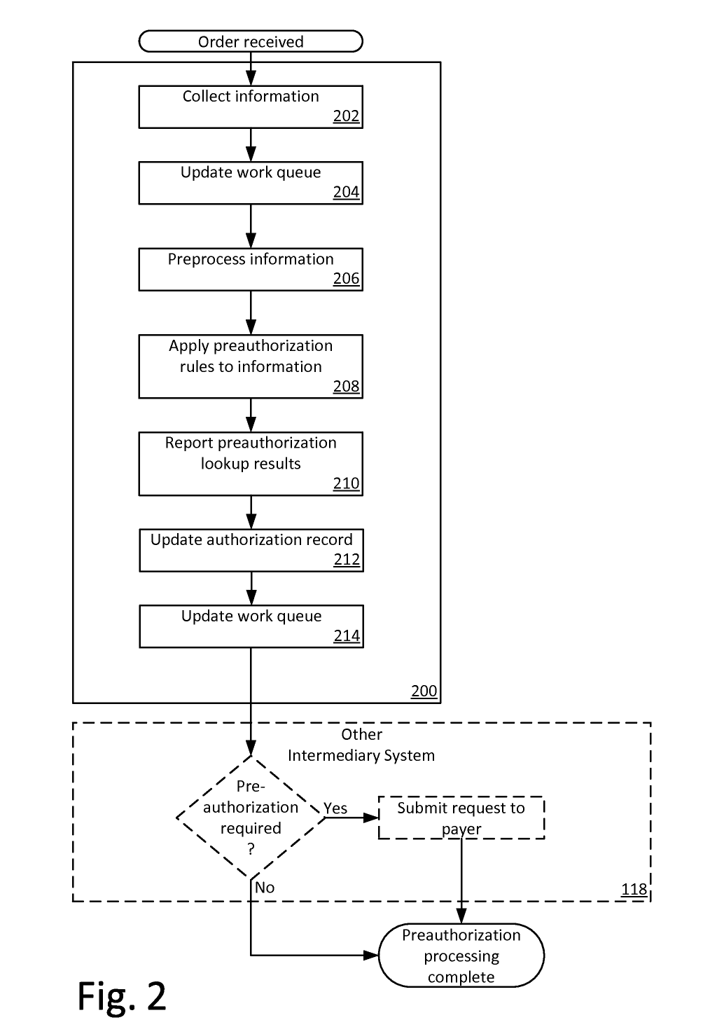

FIG. 2 is a high level flowchart of one embodiment of the method performed by the preauthorization knowledgebase system. The preauthorization knowledgebase method 200 begins when the preauthorization knowledgebase system receives an order for medical services or a preauthorization lookup inquiry from the health care provider. An order is generally associated with providing specific services to a specific patient that may serve as the basis for an insurance claim while a preauthorization lookup inquiry generally includes information requests that do not qualify as orders. As used herein, the term “order” is used generally to refer to both orders and preauthorization lookup inquiries. In various embodiments, the order information is entered into an electronic form served from preauthorization knowledgebase system or another intermediary system the displayed to the user on the client device via the user agent. In other embodiments, the provider information system displays the electronic order form, collects the information, and transmits the information to the preauthorization knowledgebase system (e.g., as an EDI transaction or web service call).

An order specifies information such as, but not limited to, patient information, insurance information, diagnosis information, and treatment information. The patient information includes information that may be used individually or collectively to uniquely identify the patient, such as, but not limited to, name, date of birth, Social Security Number. The insurance information includes information such as, but not limited to, a payer identifier, a subscriber (i.e., patient) identifier, and a plan identifier. The diagnosis and treatment information includes information such as, but not limited to, narrative descriptions of diagnoses or treatments and diagnosis and/or treatment codes, service location (e.g., office visit or surgical visit), and service type (e.g., in-patient or out-patient). In various embodiments, diagnosis and/or treatment codes are associated with a classification, coding, or nomenclature systems for medical diagnoses and/or treatments known to the health care provider and the intermediary service provider. Examples of widely recognized systems include, but are not limited to, the International Classification of Diseases, Clinical Modification (e.g., ICD-9-CM and ICD-10-CM) and Current Procedural Terminology (CPT®).

The preauthorization knowledgebase method includes an information collection operation 202 that parses the information needed by the preauthorization knowledgebase engine 104 to determine if preauthorization is required from the order. In various embodiments, the preauthorization knowledgebase system generates a message requesting a preauthorization lookup from the parsed information. For example, the preauthorization lookup message may be a call to a web service. In some embodiments, the preauthorization knowledgebase system populates an authorization form that is displayed to the user via the user agent with the parsed information. In some embodiments, the preauthorization lookup message is derived from the authorization form. In still other embodiments, the parsed information is directly supplied to the knowledgebase (e.g., as arguments) rather than being made part of a message.

Embodiments of the information collection operation 202 may check whether the order is incomplete or contains errors. Missing data may be identified where a required field on the electronic form is blank. Errors may be identified through various techniques such as, but not limited to, applying field validation rules (e.g., invalid dates, social security numbers, plan identifiers, and other alphanumeric data having required formats) and checking supplied information against reference data (e.g., comparing the supplied plan identifier against a list of plan identifiers for the payer). The user may be prompted to correct erroneous information or supply missing information before the preauthorization knowledgebase method continues.

An optional work queue update operation 204 groups the order into a work queue indicating that the order has been received and, when appropriate, that the order has been submitted to the preauthorization knowledgebase engine 104 for determining whether preauthorization is required. The work queues provide information to the health care provider about the status of a health care transaction (e.g., an order, preauthorization request, or claim) that has been submitted to the intermediary service provider or to the payer through the intermediary service provider. While the preauthorization knowledgebase engine 104 may typically return results substantially contemporaneously (e.g., within a few minutes) after the order is submitted, the work queues offer valuable information in the event of a service outage or a high volume delays the response from the preauthorization knowledgebase engine 104.

An information preprocessing operation 206 performs any necessary or desirable preprocessing to prepare the parsed information for evaluation against the preauthorization requirements. For example, a narrative description of diagnoses or treatments may be automatically translated into diagnosis and/or treatment codes. This information is added to the preauthorization lookup message.

A rule application operation 208 compares the parsed information to some or all of the rules used to determine whether the preauthorization is required for a medical service specified in the order. The general result is a yes or no answer that indicates whether preauthorization is required based on the information available to the preauthorization knowledgebase system. Some embodiments of the preauthorization knowledgebase system also provide information as to the basis of determination.

In various embodiments, the rule application operation 208 involves a series of comparisons at various hierarchical levels. The rule application operation 208 performs as many different checks as possible based on the data received. Accordingly, the specificity of the result of rule application operation 208 is directly related to the data received. If complete information is provided, the rule application information can perform all of the hierarchical comparisons and return detailed information of the results of the comparisons at the various hierarchical levels. For example, if the order specifies a payer, a plan identifier, a modality, and a diagnosis or treatment code (e.g., a CPT® code), the rule application operation 208 determines if preauthorization is required for that particular medical service under that particular plan. Similarly, if the order specifies the payer and the modality (e.g., an MRI) but no plan identifier or procedure information, the rule application operation 208 determines if preauthorization is required for that modality by that payer.

Where less than complete information is provided to the preauthorization knowledgebase system, the general result may offer guidance as to whether further inquiry is required due to the hierarchical nature of the comparisons. In various embodiments, the rules at each hierarchical level are structured to indicate that preauthorization may be required (i.e., potentially required) when any rule at lower hierarchical level in the comparison chain requires preauthorization but the information needed to reach a determination at that level is not provided. In other embodiments, the rules at each hierarchical level are structured to indicate that preauthorization is required when any rule at lower hierarchical level in the comparison chain requires preauthorization but the information needed to reach a determination at that level is not provided. In some embodiments, an affirmative result may include an indication that it is qualified as being based on incomplete information when the final answer may vary depending on one or more pieces of information not specified in the order. In some embodiments, each hierarchical level indicates that whether preauthorization is required is undetermined when the information needed to reach a determination at that level is not provided. The response from the rule application operation 208 may also indicate what information is needed to provide an authoritative answer.

It should be appreciated that the choice between configuring the rule application operation 208 to indicate that preauthorization is “required” and “potentially required” is related to the design of the overall preauthorization management process. An indication that preauthorization is required instead of potentially required when an authoritative answer is not available due to incomplete information may lead to the submission of preauthorization requests that are not required. Although inefficient, submitting an unnecessary preauthorization request may be preferable than failing to obtain preauthorization. Conversely, indicating that preauthorization is potentially required (or undetermined) may create administrative delay in expediently completing patient visits due to the time needed to obtain the additional information (e.g., identify a proper diagnosis or treatment code) before an authoritative answer can be required.

First, assume that the payer does not require preauthorization for an MRI under any circumstances. The general result returned would be that no preauthorization is required, and the results of the comparisons at the payer level, the plan level, the modality level, and the procedure level would all return the same result that preauthorization is not required. Additional information would not change the answer. In other words, simply providing the payer and modality information would be sufficient, and the health care provider need not resubmit the order with the plan identifier or the diagnosis or treatment code.

Next, assume that the payer requires preauthorization for an MRI for specific procedures based on the diagnosis. In the case of the order specifying the payer and modality, the procedure level comparison indicates that preauthorization is potentially required or undetermined because the order does not include the information needed to make the comparison and there are no lower hierarchical levels and the general result may indicate that preauthorization is required, potentially required, or undetermined based on the configuration of the rules. Similarly, the payer level, the plan level, and the modality level may return results that preauthorization is required, potentially required, or undetermined, based on the configuration of the rules, because a lower level rule that may produce a result of preauthorization being required cannot be evaluated. The rule application operation 208 may indicate that a diagnosis and/or treatment code must be provided.

Alternatively, assume that the payer requires preauthorization for an MRI for specific procedures under certain plans. As in the previous example, the results would be same; however, the rule application operation 208 would indicate that both a plan identifier and a diagnosis and/or treatment code must be provided to obtain an authoritative result.

The comparisons that make up the rules at each hierarchical level vary depend on factors such as, but not limited to, the type of data being compared. In some embodiments, the rules are in the form of a decision tree where each determination branches to a subsequent determination until the end of the branch is reached to produce a final determination. In other embodiments, the rules are heuristic where various tests are applied to reach a final determination. In various embodiments the different pieces of information in the order are tested individually. In other embodiments, multiple pieces of information are tested simultaneously. For example, multiple pieces of information may be used as parameters in nested queries against the rules database. In some embodiments, one or more pieces of information are evaluated against a lookup table.

In some embodiments, the rule application operation 208 only evaluates the order until an authoritative answer is obtained. In other words, after the first determination that indicates that preauthorization is required, it is not necessary to make further comparisons. In other embodiments, all comparisons that may be made based on the information provided will be performed even after an authoritative answer is obtained.

The order in which the hierarchical levels are evaluated need not follow a strictly ascending or descending pattern. In various embodiments, the relative arrangement of the comparisons is optimized for efficiency. For example, a rule at the procedural level may be evaluated early (e.g., after the payer level or the plan level) if procedural information is provided because the procedural information may be outcome determinative and avoid the need for further inquiry. Such a case occurs when the procedure always or never requires preauthorization for that payer or under that plan. In another example, the procedural information may be evaluated before the payer information where the procedural information is outcome determinative. Similarly, higher hierarchical level determinations that may have limited application may be given lower priority in the arrangement of rules. For example, the service line or employer levels may be used towards the end of the comparisons where the result does not eliminate the need for further inquiry in a significant number of cases.

A reporting operation 210 returns the results of the rule application operation 208. In various embodiments, the preauthorization knowledgebase engine generates a preauthorization result message that is passed back to the interface engine. For example, the preauthorization result message may be a response from a web service containing the results of the rule application operation 208. In some embodiments, the preauthorization knowledgebase system populates the electronic order form that is displayed to the user via the user agent with the information returned by the preauthorization knowledgebase engine. The report displayed to the user optionally shows which hierarchical level(s) require preauthorization for the order.

An update operation 212 updates the order record associated with the order based on the information in the preauthorization result message. The preauthorization knowledgebase system (e.g., the interface engine) may optionally update the records of any connected systems (e.g., the provider information system).

A work queue update operation 214 groups the order into one or more work queues indicating the status and/or the next step for processing the order. For instance, the order may be placed in a status-based work queue (e.g., preauthorization required or no preauthorization required), as appropriate. If the user did not supply complete information or errors were found that prevented the preauthorization knowledgebase engine from making the preauthorization determination, the order may be placed in a queue showing orders requiring the user to correct or supply additional information in order to evaluate whether preauthorization is required. Similarly, if the order contained enough information to determine that preauthorization is required but not enough to make a preauthorization request, the order may be placed in a queue for orders requiring preauthorization that need additional information or corrections. In some embodiments, preauthorization requests may be placed in multiple work queues providing the user with additional information. For example, separate status-based work queues may be created for payers, plans, or medical services (or classes thereof) giving the user more granular information (e.g., surgeries or office procedures requiring preauthorization or payers with atypical preauthorization requirements). These examples of work queue management are intended to illustrate the variety and types of work queues that may be available and should not be construed as limiting the preauthorization knowledgebase system.

At this point, the preauthorization knowledgebase method is considered complete and the result may be utilized during further processing of the order by another intermediary system. For example, the preauthorization knowledgebase system may be in communication with another or part of a larger intermediary system. In the illustrated embodiment, the intermediary system is a preauthorization management system responsible for submitting and monitoring requests for preauthorization. If the result returned by the preauthorization knowledgebase system indicates that preauthorization is required, the preauthorization management system may perform actions such as initiating submission of a preauthorization request to the payer system. Otherwise, if preauthorization is not required, no action is generally necessary by the preauthorization management system.

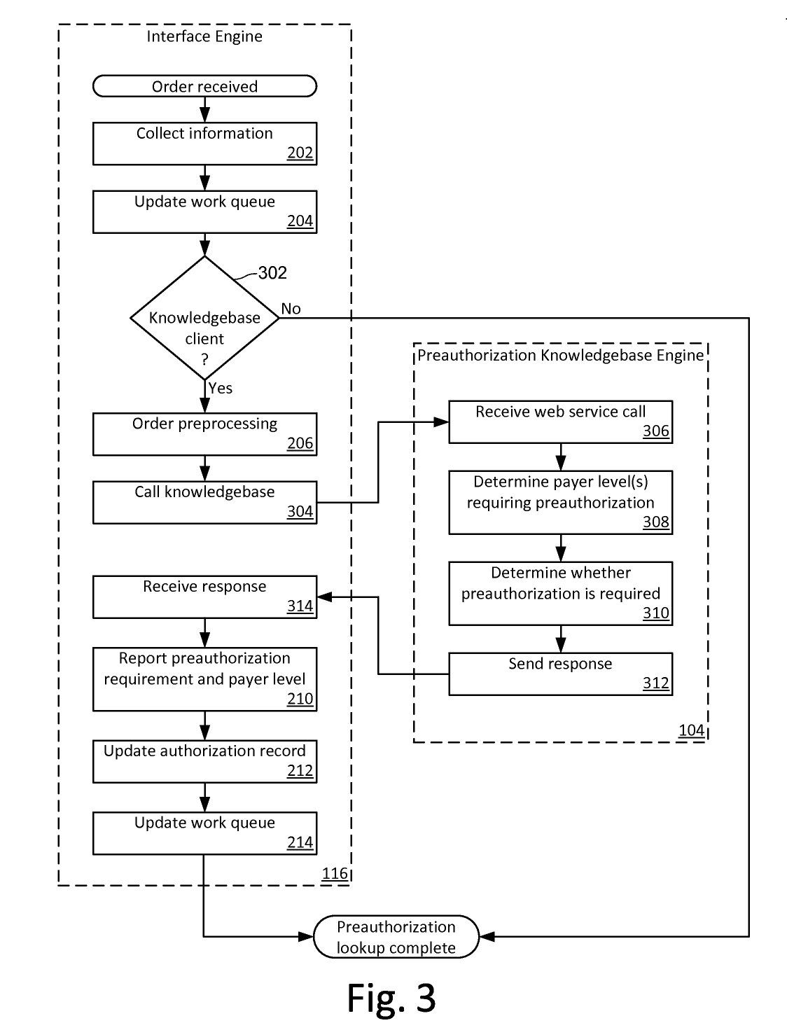

FIG. 3 is a flowchart of an alternate embodiment of the preauthorization knowledgebase method in which the preauthorization knowledgebase engine is called as a web service. The preauthorization knowledgebase method includes an information collection operation 202 that parses the information needed by the preauthorization knowledgebase engine to determine if preauthorization is required from the order. An optional work queue update operation 204 groups the order into a work queue indicating that the order has been received and, when appropriate, that the order has been submitted to the preauthorization knowledgebase engine for determining whether preauthorization is required. In this embodiment, a subscription verification operation 302 checks to see if the health care provider subscribes to the preauthorization knowledgebase service. If not, the order is not checked to determine if preauthorization is required and handling by the preauthorization knowledgebase system is considered complete.

If the health care provider is a preauthorization knowledgebase service subscriber, an information preprocessing operation 206 optionally performs any necessary or desirable preprocessing to prepare the parsed information for evaluation against the preauthorization requirements. For example, a narrative description of diagnoses or treatments may be translated into diagnosis and/or treatment codes.

A knowledgebase call operation 304 generates a request containing selected information parsed from the order, including preprocessed information, and sends the request to the preauthorization knowledgebase engine. In various embodiments, the preauthorization knowledgebase engine exposes a defined web service for consumption, and the interface engine generates a web service call to the web service endpoint containing the information for evaluation by the preauthorization knowledgebase engine. A knowledgebase call receipt operation 306 receives the request and parses the request into the different items of information used with the preauthorization rules. All or additional preprocessing of information may optionally occur during this operation.

A hierarchical level rule application operation 308 compares the supplied information to one or more of the preauthorization rules at the various hierarchical levels to determine if a medical service specified in the order requires preauthorization at a given hierarchical level. In various embodiments, the preauthorization knowledgebase engine checks each hierarchical level where the information needed to apply the rule is supplied in the request.

A preauthorization result operation 310 determines whether preauthorization is required for a medical service specified in the order from the results of the hierarchical level rule application operation and generates a response containing the ultimate preauthorization requirement determination and the results of the hierarchical level rule application operation 308. A knowledgebase response operation 312 sends the response to the interface engine in a format corresponding to the request format.

A knowledgebase response receipt operation 314 receives the response and parses the various items of information from the response. The reporting operation 210 displays the results generated by the preauthorization knowledgebase engine to the user via the user agent. In various embodiments, the interface engine populates an electronic form that is displayed to the user via the user agent with the information returned by the preauthorization knowledgebase engine. The electronic form optionally allows the user to view the results of the preauthorization determinations at the individual hierarchical levels.

An update operation 212 updates the order record associated with the order based on the information in the preauthorization result message. The preauthorization knowledgebase system may optionally update the records of any connected systems (e.g., the provider information system). The work queue update operation 214 groups the order into one or more work queues indicating the status and/or the next step for processing the order.

After the preauthorization knowledgebase method completes, another intermediary system may continue processing of the order. For example, a preauthorization request may be submitted to the payer or a claim for payment may be generated.

Embodiments of the invention may be implemented via local and remote computing and data storage systems. Such memory storage and processing units may be implemented in a computing device, such as computing device 400. Any suitable combination of hardware, software, or firmware may be used to implement the memory storage and processing unit. For example, the memory storage and processing unit may be implemented with computing device 400 or any other computing devices 418, in combination with computing device 400, wherein functionality may be brought together over a network in a distributed computing environment, for example, an intranet or the Internet, to perform the functions as described herein. Such systems, devices, and processors (as described herein) are examples and other systems, devices, and processors may comprise the aforementioned memory storage and processing unit, consistent with embodiments of the invention.

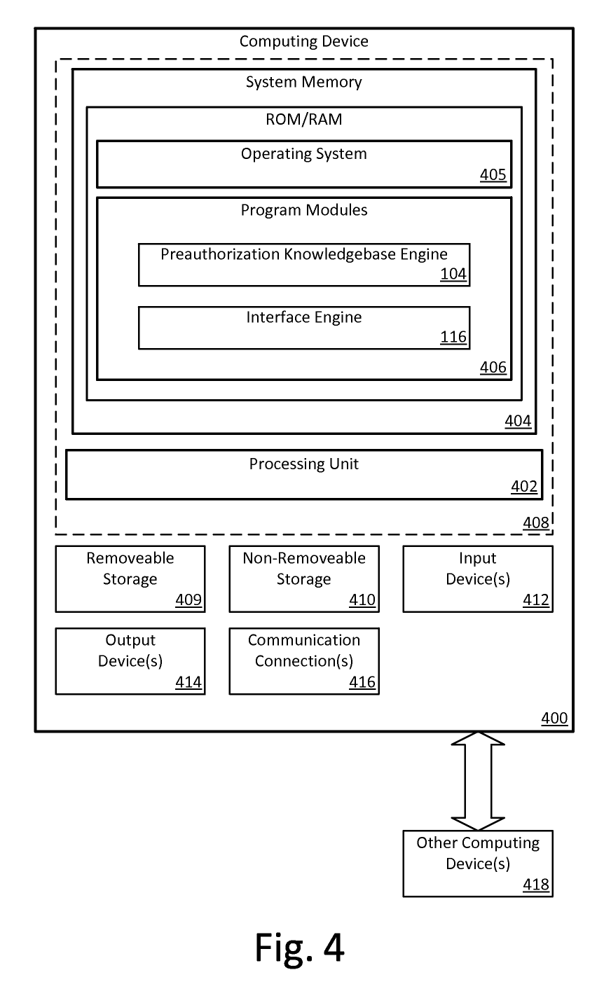

FIG. 4 illustrates one embodiment of a computing device suitable to implement embodiments of the invention. The computing device 400 may include at least one processing unit 402 and a system memory 404. The system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a preauthorization knowledgebase engine 104, a user agent 124, and/or an interface engine 116 having sufficient computer-executable instructions, which when executed, performs functionalities as described herein. Operating system 405, for example, may be suitable for controlling the operation of computing device 400. Furthermore, embodiments of the invention may be practiced in conjunction with a graphics library, other operating systems, or any other application program and is not limited to any particular application or system. This basic configuration is illustrated by those components within a dashed line 408. Computing device 400 may also include one or more input device(s) 412 (keyboard, mouse, pen, touch input device, etc.) and one or more output device(s) 414 (e.g., display, speakers, a printer, etc.).

The computing device 400 may also include additional data storage devices (removable and/or non-removable) such as, for example, magnetic disks, optical disks, or tape. Such additional storage is illustrated by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

Program modules, such as the preauthorization management engine 104, may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable user electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system.

Although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data and/or computer-executable instructions readable by a computing device. Computer-readable storage medium do not include communications media.

Embodiments of the present invention may be utilized in various distributed computing environments where tasks are performed by remote processing devices that are linked through a communications network.

The description and illustration of one or more embodiments provided in this application are intended to provide a complete thorough and complete disclosure the full scope of the subject matter to those skilled in the art and not intended to limit or restrict the scope of the invention as claimed in any way. The embodiments, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method of determining whether a medical service requires preauthorization, the method comprising the acts of:
receiving, at a preauthorization knowledgebase system, an order from a health care provider system specifying items of information related to the medical service;
evaluating at least one selected item of information from the order against a set of rules indicating whether preauthorization is required; and
returning a response to the health care provider system indicating whether preauthorization is required.

2. The method of claim 1 characterized in that the set of rules indicates whether preauthorization is required at one or more selected hierarchical levels.

3. The method of claim 2 characterized in that the hierarchical levels are selected from a payer level, a plan level, a service line level, a modality level, a contract level, an employer level, and a procedure level.

4. The method of claim 2 characterized in that the preauthorization knowledgebase system evaluates rules at each hierarchical level for which the order provides information evaluated at that hierarchical level.

5. The method of claim 2 further comprising the act of indicating which of the hierarchical levels require preauthorization for the medical service in the response.

6. The method of claim 1 further comprising the act of prompting a user to supply information needed to determine whether preauthorization is required for the medical service.

7. The method of claim 1 further comprising the act of updating an information system maintained by the health care provider with information from the response from the preauthorization knowledgebase system.

8. The method of claim 1 further comprising the acts of:
parsing selected items of information from the order by the preauthorization knowledgebase system for evaluation to determine whether preauthorization is required;
placing the selected items of information parsed from the order into corresponding fields of a message; and
sending the message to a knowledgebase.

9. The method of claim 8 characterized in that the message is a web service call.

10. A system for determining whether a medical service requires preauthorization, the system comprising:
a rules memory storing the set of preauthorization rules;
a preauthorization knowledgebase engine operable to:
receive an order from a health care provider system related to the medical service;
parse information from the order for comparison against a set of preauthorization rules indicating whether preauthorization is required at one or more hierarchal levels;
evaluate information from the order against a preauthorization rule at a selected hierarchal level; and
return a response to the health care provider system indicating whether preauthorization is required for the medical service at one or more hierarchal levels.
a computing device having a processor and memory for storing and executing the preauthorization knowledgebase engine.

11. The system of claim 10 characterized in that the system further comprises a work queue memory for storing information about orders grouped into work queues based on the output of the preauthorization knowledgebase engine.

12. The system of claim 10 characterized in that the hierarchical levels are selected from a payer level, a plan level, a service line level, a modality level, a contract level, an employer level, and a procedure level.

13. The system of claim 10 characterized in that the preauthorization knowledgebase system evaluates rules at each hierarchical level for which the order provides information used at that hierarchical level.

14. The system of claim 10 further comprising the act of updating an information system maintained by the health care provider with information from the response from the preauthorization knowledgebase system.

15. The system of claim 10 characterized in that the system further comprises:
a front end accessible from a user agent on a client device, the front end operable to parse information from the order for comparison against the set of preauthorization rules and generate a web service call containing the information;
a web interface endpoint operable to receive the web service call and extract the information from the web service call; and
a web service associated with the web interface endpoint operable to evaluate the information parsed from the order against the set of preauthorization rules and return a response to the front indicating whether preauthorization is required for the medical service.

16. A computer readable medium containing computer executable instructions which, when executed by a computer, perform a method for determining whether a medical service requires preauthorization, the method comprising the steps of:
receiving, at a preauthorization knowledgebase system, an order from a health care provider system containing items of information related to the medical service;
evaluating at least one selected item of information from the order against a set of rules indicating whether preauthorization is required; and
returning a response to the health care provider system indicating whether preauthorization is required.

17. The computer readable medium of claim 16 characterized in that the set of rules indicates whether preauthorization is required at one or more selected hierarchical levels.

18. The computer readable medium of claim 17 further comprising the act of indicating which of the hierarchical levels require preauthorization for the medical service in the response.

19. The computer readable medium of claim 17 characterized in that the hierarchical levels are selected from a payer level, a plan level, a service line level, a modality level, a contract level, an employer level, and a procedure level.

20. The computer readable medium of claim 17 characterized in that the preauthorization knowledgebase system evaluates rules at each hierarchical level for which the order provides information used at that hierarchical level.
